(19) United States
(12) Patent Application Publication
(10) Pub. No.: US 2010/0261514 A1
(43) Pub. Date: Oct. 14, 2010

(54) HAND-MANIPULABLE INTERFACE METHODS AND SYSTEMS

(76) Inventors: Michael S. Gramelspacher, Greenfield, IL (US); Rory T. Sledge, O'Fallon, IL (US)

Correspondence Address: POLSINELLI SHUGHART PC, 700 W. 47TH STREET, SUITE 1000, KANSAS CITY, MO, 64112-1802, US

(21) Appl. No.: 12/759,427

(22) Filed: Apr. 13, 2010

Related U.S. Application Data
(60) Provisional application No. 61/168,809, filed on Apr. 13, 2009.

(51) Int. Cl. A63F 9/24; G09G 5/00; A63F 13/00

(52) U.S. Cl. 463/9; 345/156; 463/31; 463/43

(57) ABSTRACT

Methods and systems for a hand-manipulable interface are described. In one embodiment, a manipulable interface device may have a movable portion and a non-moveable base portion. A position sensing subsystem may be deployed in the manipulable interface device to detect a user interaction based on movement of the movable portion relative to the non-movable portion. A control unit may be coupled to the positioning sensing subsystem to translate the user interaction into an instruction on the manipulable interface device and generate a visual display on the manipulable interface device based on the instruction. Additional methods and systems are disclosed.

### CROSS-REFERENCE TO A RELATED APPLICATION

This application claims the benefit of United States Provisional Patent Application entitled “Methods and Systems for a Hand-Manipulable Interface Device”, Ser. No. 61/168,809, filed 13 Apr. 2009, the entire contents of the applications are herein incorporated by reference.

### FIELD

This application relates to methods and systems for use and manufacture of an interface device and more specifically to methods and systems to interpret manipulation of a moveable portion relative to a base as an input to a device and update an associated display to reflect the input.

### BACKGROUND

Computer games, video/console games, handheld electronic games, and non-electronic puzzle games have been popular for decades. Many games developers have increased the appeal of games through advances in processing power, visual realism, and complex game content. More recently, developers have started to evolve the human-machine interface to increase the appeal of their games. Most notably are the motion-tracking features of the NINTENDO WII, the gesture recognition capability of the EYETOY for SONY PLAYSTATION, and touch screen interfaces for NINTENDO DS and APPLE IPHONE.

### BRIEF DESCRIPTION OF THE DRAWINGS

FIG. 1 is a perspective view of a hand-manipulable interface device with a slightly rotated moveable portion, according to an example embodiment;

FIG. 2 is a back elevation view of the hand-manipulable interface device of FIG. 1, according to an example embodiment;

FIG. 3 is a top elevation view of the hand-manipulable interface device of FIG. 1, according to an example embodiment;

FIG. 4 is a front elevation view of the hand-manipulable interface device of FIG. 1, according to an example embodiment;

FIG. 5 is a perspective view of the hand-manipulable interface device of FIG. 1, in an exploded view, according to an example embodiment;

FIGS. 6 and 7 are diagrams of degrees of freedom for manipulation of a moveable portion relative to a base unit, according to example embodiments;

FIG. 8 is a diagram of a moveable portion rotated in relation to a base unit, according to an example embodiment;

FIG. 9 is a block diagram of an interface system that may be deployed within the interface device of FIG. 1, according to an example embodiment;

FIGS. 10 and 11 are diagrams of position sensing subsystems that may be deployed within the interface system of FIG. 9, according to example embodiments;

FIG. 12 is a block diagram of a method of interfacing, according to an example embodiment;

FIGS. 13-15 illustrate display configurations and updating the configurations in relation to identified instructions, according to example embodiments;

FIG. 16 illustrates a block diagram of a method for producing a random puzzle and a randomized second puzzle, according to an example embodiment;

FIG. 17 illustrates a block diagram of a method of game play, according to an example embodiment;

FIG. 18 illustrates the steps of manipulating a displayed puzzle to match a target puzzle, according to an example embodiment.

FIG. 19 is a block diagram of an example gaming subsystem that may be deployed within the hand-manipulable interface device of FIG. 1, according to an example embodiment; and

FIG. 20 is a block diagram of a machine in the example form of a computer system within which a set of instructions for causing the machine to perform any one or more of the methodologies discussed herein may be executed.

### DETAILED DESCRIPTION

Example methods and systems of a hand-manipulable interface are described. In the following description, for purposes of explanation, numerous specific details are set forth in order to provide a thorough understanding of example embodiments. It will be evident, however, to one of ordinary skill in the art that embodiments of the invention may be practiced without these specific details.

In some embodiments, systems and methods for detecting user interactions that offers natural and seamless interaction between a user and a display are described. In some embodiments, these systems and methods are integrated into handheld gaming and puzzle devices. In other embodiments, the methods and systems can also be integrated into non-gaming devices including mobile/smart phones, global positioning systems (GPS) and digital picture viewers, and the like. In some embodiments, interactive entertainment methods and systems are described.

The methods and system described herein may be used with a variety of real world applications. These applications include, but are not limited to, digital photo/video manipulation, viewing and browsing, web site and web application navigation, mobile phone or smart phone interface, Global Positioning System (GPS) interface, camera panning/zooming control, Personal Digital Assistant (PDA) interface, clock/timer setting, calculator interface, electronic dictionary/translator interface, general cursor or selection control, video game interface, a TETRIS game, an electronic RUBIK'S CUBE game, or other handheld electronic game interfaces. In the instance of a TETRIS implementation, for example the methods and systems may be used to control the rotation, left-to-right position, falling rate of tetrominoes, and other aspects of the game.

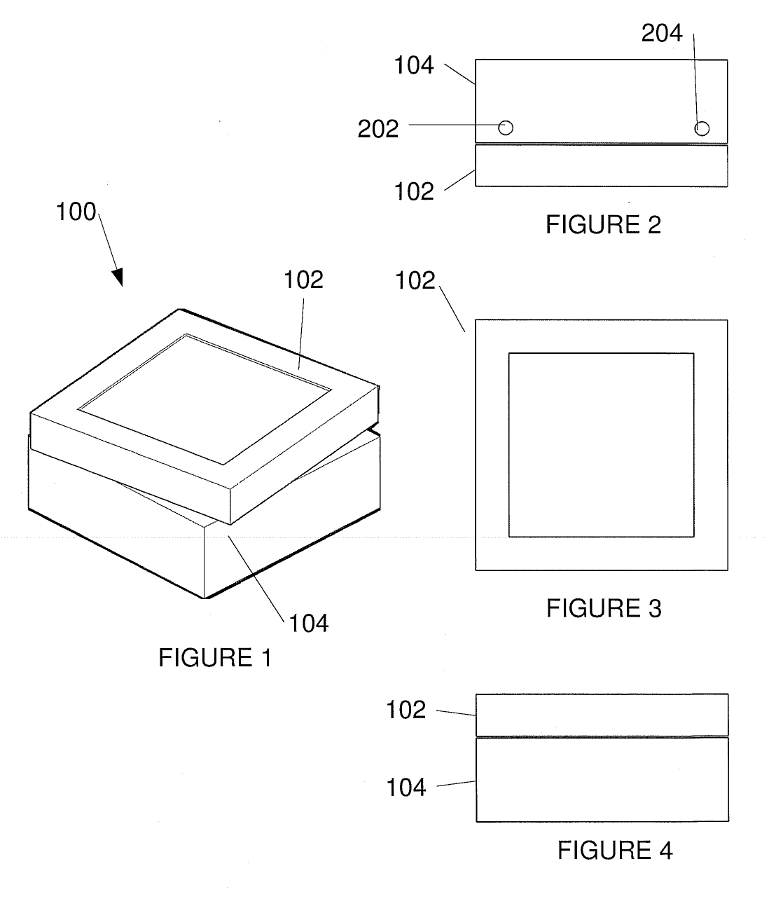

FIG. 1 illustrates a hand-manipulable interface device 100. In one embodiment, the hand-manipulable interface device 100 includes a moveable portion 102 and a non-moveable base unit 104. The moveable portion 102 and the non-moveable base unit 104 in one embodiment are shown to have a square or rectangular shape, but may be circular, trapezoidal, spherical or any other form factor desirable to the design in other embodiments.

Generally, the moveable portion 102 is mechanically associated with the non-moveable base unit 104. The moveable portion 102 may be physically manipulated relative to the non-moveable base unit 104 within some range of motion. As shown in FIG. 1, the moveable portion 102 is slightly twisted relative to the non-moveable base unit 104. In some embodiments, while at rest and not being manipulated, the moveable portion 102 may return to a home position relative to the non-moveable base unit 104. In some embodiments, there may be multiple moveable portions 102 associated with the non-moveable base 104. For example, two moveable portions may be arranged opposite each other to form a front and a back, six moveable portions may be arranged orthogonally to each other to form six sides of a cube, or multiple moveable portions may be arranged in any manner or number convenient to the design.

In some embodiments, the mobility of the moveable portion 102 and the non-moveable base unit 104 is relative. Thus, generally a user moves the moveable portion 102 relative to the non-moveable base unit 104. However, it should be appreciated that in some embodiments the non-moveable base unit 104 is moveable and the moveable portion 102 may not be moveable. In still other embodiments, both the non-moveable base unit 104 is moveable and the moveable portion 102 may be moveable relative to each other.

FIG. 2 illustrates a back elevation view of the hand-manipulable interface device 100 (see FIG. 1). In one embodiment, the hand-manipulable interface device 100 includes additional input units 202, 204. The additional input units 202, 204 may include buttons or other sensors. In some embodiments, the additional input units 202, 204 are electrically and mechanically associated with the hand-manipulable interface device 100 but are not used in sensing the position of the moveable portion 102 relative to the non-moveable base unit 104.

A portion of the additional input units 202, 204 is generally viewable on the back elevation view. However, the input units 202, 204 may be in other locations, internal or external to, the hand-manipulable interface device 100.

FIG. 3 illustrates a top elevation view of the hand-manipulable interface device 100 (see FIG. 1), according to an example embodiment. In one embodiment, the home position, or a non-manipulated position, is achieved when the moveable portion 102 is geometrically aligned with the non-moveable base unit 104 as shown in the top elevation view.

FIG. 4 illustrates a front elevation view of the hand-manipulable interface device 100 in the non-manipulated position shown in FIG. 3, according to an example embodiment.

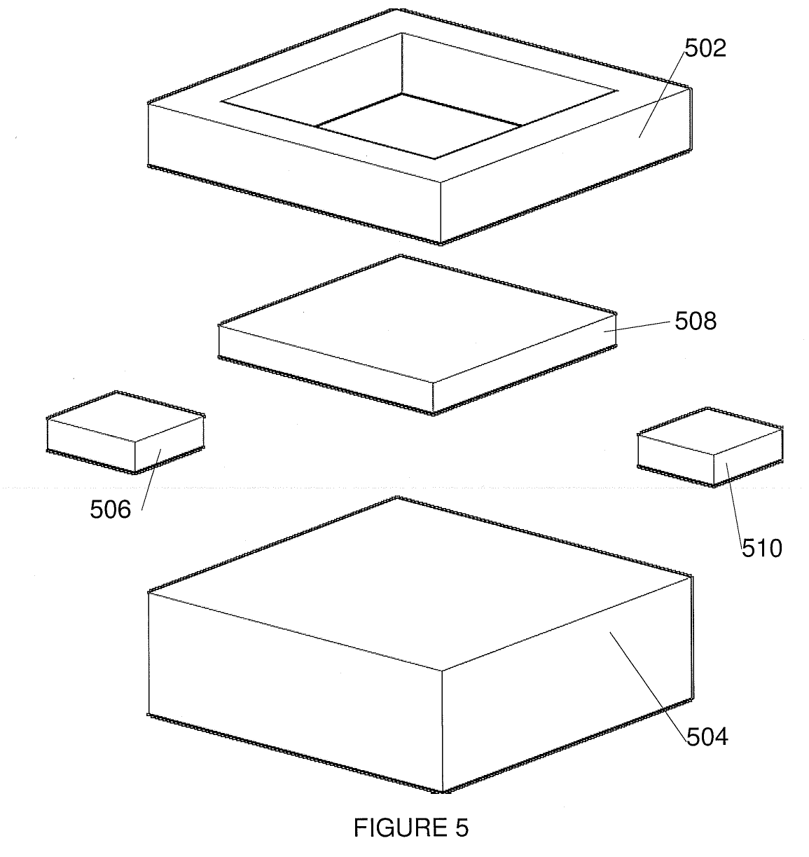

FIG. 5 illustrates the hand-manipulable interface device 100 (see FIG. 1) in an exploded view, according to an example embodiment.

In some embodiments, the hand-manipulable interface device 100 includes a display bezel 502, a base 504, a controller 506, a display 508, and a position sensing subsystem 510. More or less elements may be included in other embodiments.

In one embodiment, the display bezel 502 is the moveable portion 102 (see FIG. 1) and is an element of the hand-manipulable interface device 100 normally associated with the display 508 for the purpose of handling, enclosure, protection (see FIG. 1) and aesthetics.

In one embodiment, the stationary base 504 is the non-moveable base unit 104 and is a portion of the hand-manipulable interface device 100 held in place by a hand of a user or other surface while manipulating the display bezel 502. The display bezel 502 may be electrically coupled, mechanically coupled, or electro-mechanically coupled to the stationary base 504.

The display 508, the position sensing subsystem 510, and the controller 506 each may be independently physically associated with the moveable display bezel 502 or the stationary base 504. The display 508, the position sensing subsystem 510, and the controller 506 each may also be split into subelements that are divided in association between the display bezel 502 and the stationary base 504.

In one embodiment, physical manipulations of the display bezel 502 relative to the stationary base 504 may appear to be direct physical manipulations of the display 508 relative to the stationary base 504.

In general, the position sensing subsystem 510 detects user interactions based on the physical manipulations. The controller 506 translates the user interaction into an instruction and generates a visual display for presentation on the display 508 based on the instruction.

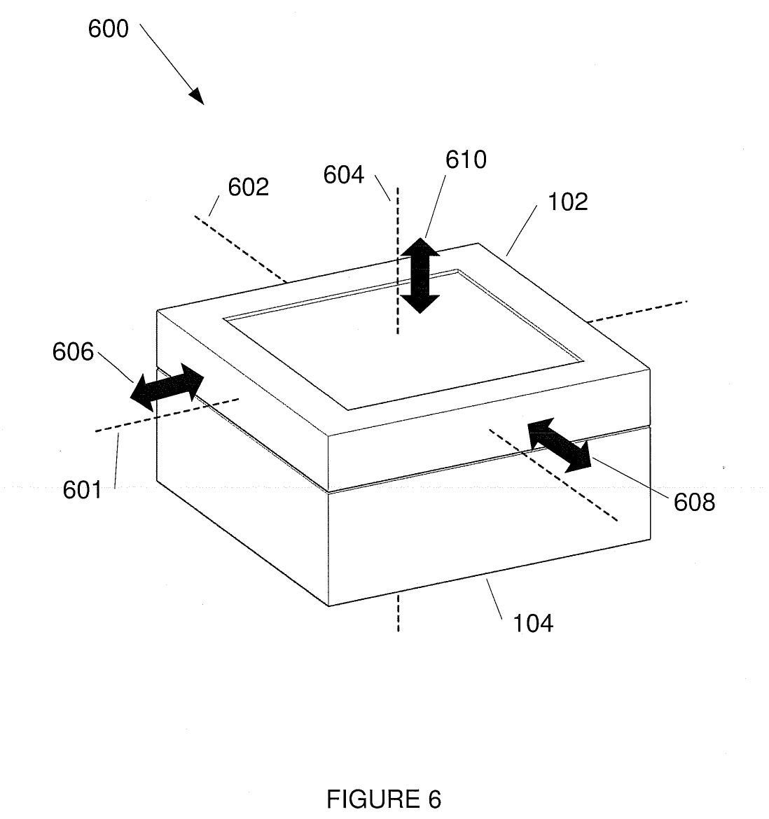

FIG. 6 is a diagram 600 of degrees of freedom for manipulation of the moveable portion 102 relative to the non-moveable base unit 104 (see FIG. 1), according to an example embodiment. When manipulated, the moveable portion 102 relative to the non-moveable base unit 104, may have translational movement in multiple directions. In one embodiment, an axis 601, an axis 602 and an axis 604 make up a standard orthogonal 3D coordinate system such as a standard X, Y, Z rectangular (Cartesian) coordinate system. A bidirectional arrow 606 indicates a positive and negative translational movement degree of freedom that the moveable portion 102 has relative to the non-moveable base unit 104 along the axis 601. A bidirectional arrow 608 indicates a positive and negative translational movement degree of freedom that the moveable portion 102 has relative to the non-moveable base unit 104 along the axis 602. A bidirectional arrow 610 indicates a positive and negative translational movement degree of freedom that the moveable portion 102 has relative to the non-moveable base unit 104 along the axis 604. In one embodiment, the moveable portion 102 may be translated relative to the non-moveable base unit 104 in the direction of the bidirectional arrows 606, 608, 610 or any combination of the three directions, allowing for translational freedom in any direction in 3D space.

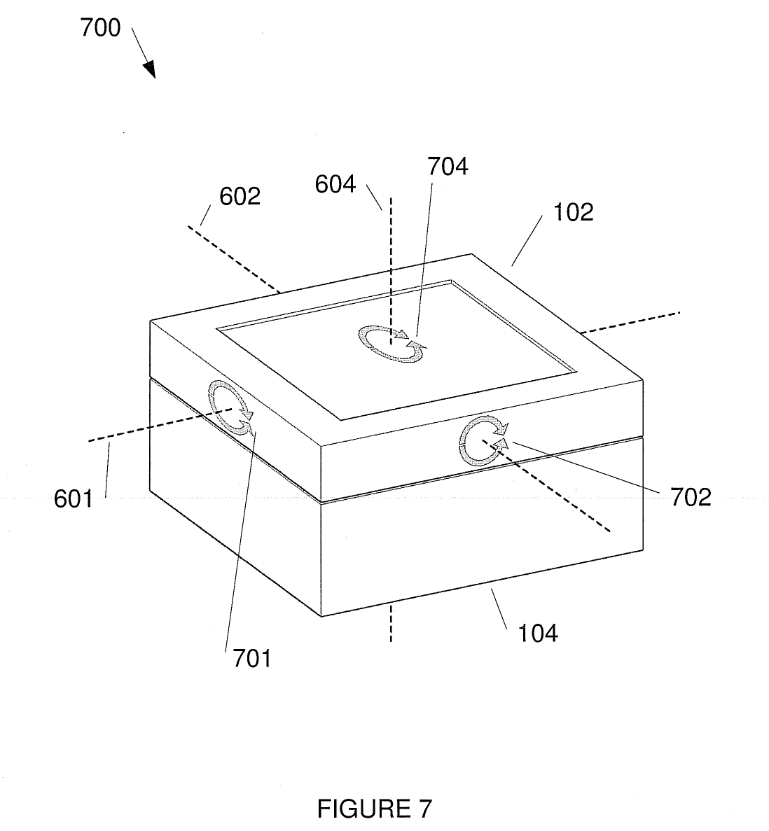

FIG. 7 is a diagram 700 of degrees of freedom for manipulation of the moveable portion 102 relative to the non-moveable base unit 104 (see FIG. 1), according to an example embodiment. In one embodiment, in addition to translational movement shown in the diagram 600 (see FIG. 6), when manipulated, the moveable portion 102 relative to the non-moveable base unit 104, may have rotational movement in multiple directions. A bidirectional arrow 701 indicates a positive and negative rotational movement degree of freedom that the moveable portion 102 has relative to the non-moveable base unit 104 about the axis 601 (see FIG. 6). A bidirectional arrow 702 indicates a positive and negative rotational movement degree of freedom that the moveable portion 102 has relative to the non-moveable base unit 104 about the axis 602. A bidirectional arrow 704 indicates a positive and negative rotational movement degree of freedom that the moveable portion 102 has relative to the non-moveable base unit 104 about the axis 604. In one embodiment, the moveable portion 102 may be rotated relative to the non-moveable base unit 104 in the direction of the bidirectional arrows 701, 702, 704 or any combination of the three, allowing for rotational freedom in any direction in 3D space. In one embodiment, the moveable portion 102 has both rotational degrees of freedom and translational degrees of freedom (see FIG. 6) relative to the non-moveable base unit 104.

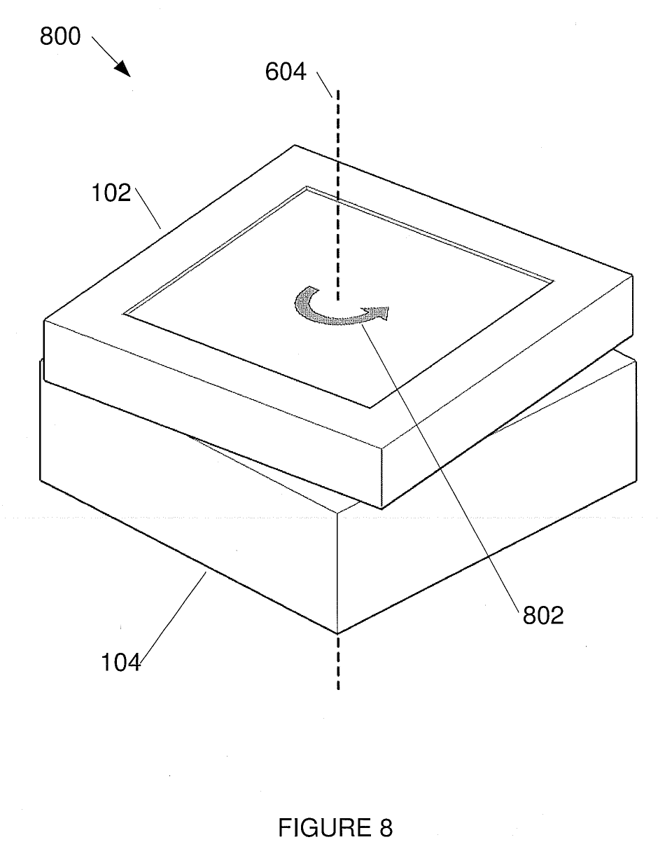

FIG. 8 is a diagram 800 of an example rotated position that the moveable portion 102 has relative to the non-moveable base unit 104 (see FIG. 1), according to an example embodiment. In this example movement, relative to the non-moveable base unit 104, the moveable portion 102 is rotated slightly about the axis 604 (see FIG. 6) in the direction of an arrow 802. In one embodiment, the range of any translational or rotational movement of the moveable portion 102 relative to the base unit 204 is limited to a specific translational distance and/or rotational angle.

In one embodiment, after a user applies a force to translate and/or rotate the moveable portion 102 relative to the non-moveable base unit 104, the moveable portion 102 automatically returns to a non-translated and/or non-rotated home position when the force applied by the user ceases.

In another embodiment, after a user applies a force to translate and/or rotate the moveable portion 102 relative to the non-moveable base unit 104, the moveable portion 102 remains in the translated and/or rotated position when the force applied by the user ceases.

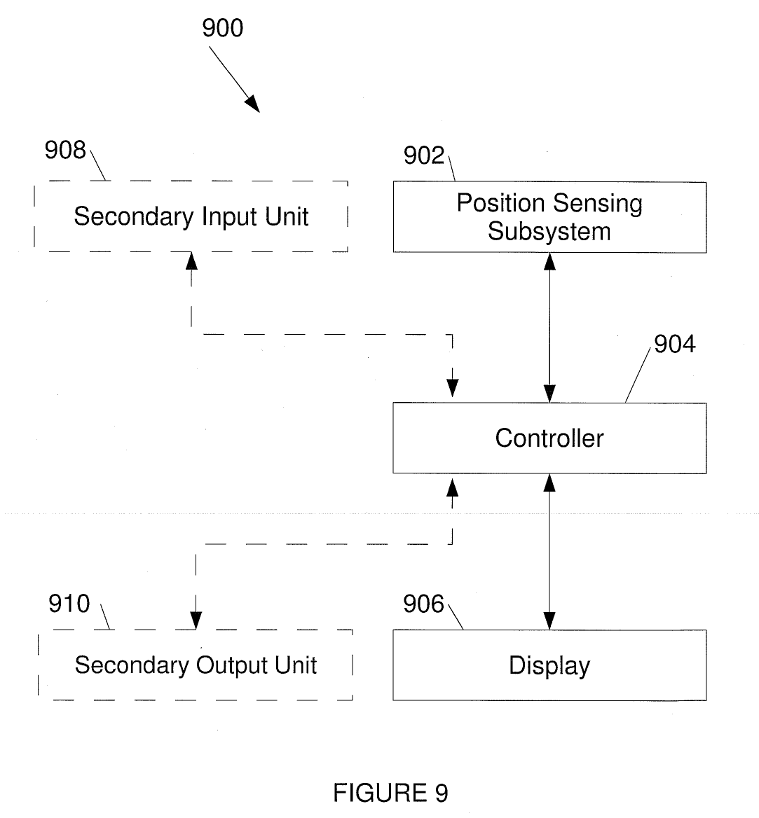

FIG. 9 illustrates an interface system 900 that may be deployed in interface device 100 (see FIG. 1) to enable interfacing, according to an example embodiment. In one embodiment, elements of the interface system 900 may be deployed in the hand-manipulable interface device 100 (see FIG. 1) and correspond to or otherwise include the functionality of the controller 506, the display 508, and the position sensing subsystem 510 (see FIG. 5).

In one embodiment, a controller 904 sets up and otherwise controls the interface system 900 and interacts with input units including a position sensing subsystem 902 and a secondary input unit 908, and output units including a display 906 and a secondary output unit 910. Input units or output units may be bidirectional, having characteristics of both an input unit and an output unit.

In one embodiment, the position sensing subsystem 902 is an input unit that translates movement of the moveable portion 102 relative to the non-moveable base unit 104 (see FIG. 1) into signals receivable by the controller 904.

The secondary input system 908, when used with the interface system 900, is an input unit that allows for additional input to the controller 904. In some embodiments, the additional input is not related to the relative movement of the moveable portion 102 to the non-moveable base unit 104.

In one embodiment, the display 906 is an output unit that allows for visual presentation to the user, output from the controller 904 that is related to the movement of the moveable portion 102 relative to the non-moveable base unit 104, and/or input from the secondary input system 908. The secondary output system 910 may be used in some embodiments as an output unit that allows for additional output from the controller 904. In one embodiment, the secondary output system 910 presents to the user, output from the controller 904 that may be associated with the secondary input system 908, the position sensing subsystem 902, and/or internal information otherwise produced or calculated by the controller 904.

In general, the controller 904 translates the user interaction into an instruction and generates a visual display based on the instruction. The controller 904 may consist of a collection of fixed logic devices, a programmable logic device, an ASIC, or a device capable of executing programmed instructions such as a microcontroller or microprocessor.

In some embodiments, the controller 904 is capable of interacting with bidirectional units that have both input unit and output unit characteristics. The controller 904 may include analog-to-digital and/or digital-to-analog conversion functionality. In some embodiments, the controller 904 transmits information to one or more output units based on one or more input units, the current state of the one or more output units, the internal state of the controller 904, or other internal mechanisms such as timers. The controller 904 may interpret similar input differently based on various factors such as the internal state of the controller 904.

The position sensing subsystem 902 is an input unit that is capable of translating physical movement or position into electrical signals or other signals. The position sensing subsystem 902 may include a single sensor or multiple sensors. For example, the sensors may include an array of tactile buttons or pushbuttons, conductive contacts, slide switches, linear or rotational potentiometers, rubber or silicone buttons, angular or rotary encoders, linear encoders, or any other sensor including electrical field, Hall Effect, reed switches, magnetic, wireless, capacitive, pressure, piezo, acceleration, tilt, infrared, or optical.

In one embodiment, the secondary input unit 908 is a similar sensor to the position sensing subsystem 902. In another embodiment, the secondary input system 908 includes an optical imager, connection to a personal computing system, wireless data connection, wired data connection, data storage card interface, game cartridge interface, global positioning system (GPS), infrared data transceiver or environmental sensor such as ambient light, temperature, or vibration, or the like.

The display 906 is an output unit capable of converting information received from the controller 904 into visual information. The display 906 may include light emitting diodes (LEDs), an array of LEDs, an array of collections of LEDs or multicolor LEDs, a color, monochrome, grayscale or field sequential liquid crystal display (LCD), vacuum florescent display (VFD), organic LED (OLED) display, electronic ink (e-ink) display, projector or any other system capable of representing visual information.

In one embodiment, the secondary output unit 910 is a display similar to display 906. In other embodiments, the secondary output unit 910 may provide auditory output such as a buzzer, speaker, piezo element or other electro-mechanical sounding element. The secondary output unit 910 may provide tactile output such as an offset motor, vibrator motor, electric shock, force feedback or gyroscopic forces. The secondary output unit 910 may produce mechanical action such as moving some portion of the device, unlocking a catch, or actuating a hinge. The secondary output unit 910 may provide connectivity to an external system via wired or wireless data interface.

Although the secondary input unit 908 and the secondary output unit 910 are identified as being secondary sources of input and output, the secondary input unit 908, the secondary output unit 910, or both may be primary input and output respectively.

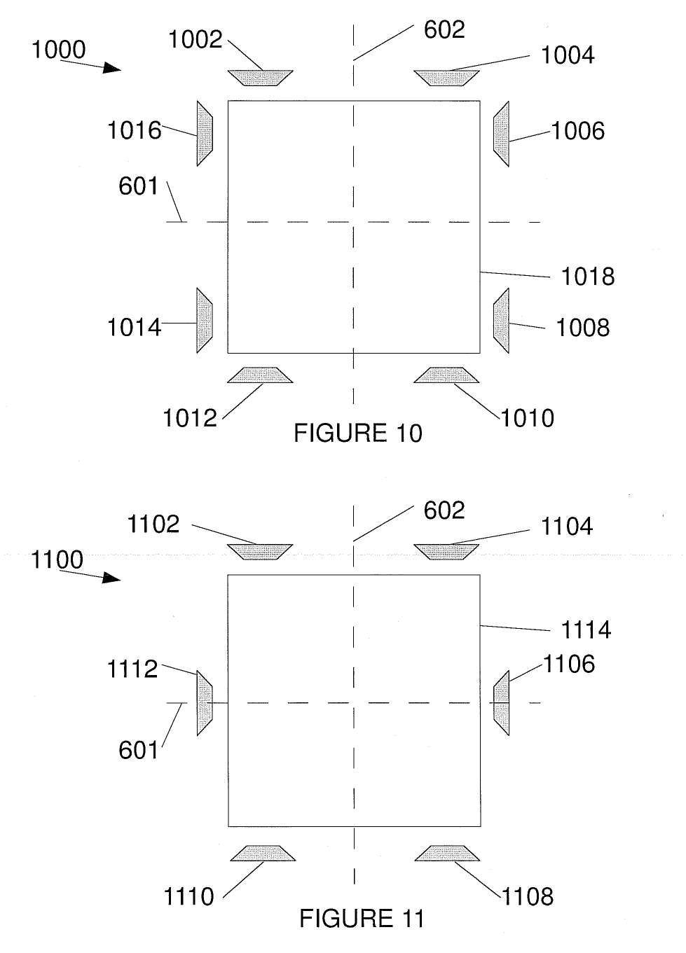

FIG. 10 illustrates an example position sensing subsystem 1000 that may be deployed as the position sensing subsystem 902 in the interface system 900 (see FIG. 9), in one embodiment, or otherwise deployed in another system. A single sensor or multiple sensors are included in the position sensing subsystem 1000 to determine the position or movement of the moveable portion 102 relative to the non-moveable base unit 104 (see FIG. 1). In one embodiment, the sensors of the position sensing subsystem 1000 are switches 1002-1016 and a switch actuator 1018. Other components may also be included.

In one embodiment, the switch actuator 1018 is a part of the moveable portion 102 and the switches 1002-1016 are physically associated with the non-moveable base unit 104.

In another embodiment, the switch actuator 1018 is a part of the non-moveable base unit 104 and the switches 1002-1016 are physically associated with the moveable portion 102.

In some embodiments, the movement of switch actuator 1018 is determined by the state of the switches 1002-1016. The following partial truth table (Table 1) indicates the detected motion of the switch actuator 1018 based on the state of the switches 1002-1016. In general, a logic “1” on the table indicates an activated switch state and a logic “0” on the table indicates a non-activated switch state. Not all activated combinations of the switches 1002-1016 are entered into this table. Some combinations may not be physically possible depending on the configuration of the switch actuator 1018 relative to the switches 1002-1016. Those that may be possible, but are not indicated in the table may be ignored, translated to an alternative movement, interpreted as similar to one of the listed movements, or otherwise processed.

TABLE 1

| Switch | Switch | Switch | Switch | Switch | Switch | Switch | Switch | Detected |
|---|---|---|---|---|---|---|---|---|
| 1002 | 1004 | 1006 | 1008 | 1010 | 1012 | 1014 | 1016 | Motion |
| 1 | 1 | 0 | 0 | 0 | 0 | 0 | 0 | Move in positive |
| | | | | | | | | direction along the |
| | | | | | | | | axis 602 |
| 0 | 0 | 0 | 0 | 1 | 1 | 0 | 0 | Move in negative |
| | | | | | | | | direction along the |
| | | | | | | | | axis 602 |
| 0 | 0 | 1 | 1 | 0 | 0 | 0 | 0 | Move in positive |
| | | | | | | | | direction along the |
| | | | | | | | | axis 601 |
| 0 | 0 | 0 | 0 | 0 | 0 | 1 | 1 | Move in negative |
| | | | | | | | | direction along the |
| | | | | | | | | axis 601 |
| 1 | 0 | 1 | 0 | 1 | 0 | 1 | 0 | Rotate clockwise |
| 0 | 1 | 0 | 1 | 0 | 1 | 0 | 1 | Rotate counter- |
| | | | | | | | | clockwise |

FIG. 11 illustrates another example position sensing subsystem 1100 that may be deployed as the position sensing subsystem 902 in the example interface system 900 (see FIG. 9), or otherwise deployed in another system. A single sensor or multiple sensors are included in the position sensing subsystem 1100 to determine the position or movement of the moveable portion 102 relative to the non-moveable base unit 104 (see FIG. 1). In one embodiment, the sensors of the position sensing subsystem 1100 are switches 1102-1112 and a switch actuator 1114. Other sensors may also be included.

In one embodiment, the switch actuator 1114 is a part of the moveable portion 102 and the switches 1102-1112 are physically associated with the non-moveable base unit 104. In another embodiment, the switch actuator 1114 is a part of the non-moveable base unit 104 and the switches 1102-1112 are physically associated with the moveable portion 102.

The movement of the switch actuator 1114 is determined by the state of the switches 1102-1112. The following partial truth table (Table 2) indicates the detected motion of the switch actuator based on the state of the switches 1102-1112. In general, a logic “1” on the table indicates an activated switch state and a logic “0” on the table indicates a non-activated switch state. Not all activated combinations of the switches 1102-1112 are entered into this table. Some combinations may not be physically possible depending on the configuration of the switch actuator 1114 relative to the switches 1102-1112. Those that may be possible, but are not indicated in the table may be ignored, translated to an alternative movement, interpreted as similar to one of the listed movements, or otherwise processed.

TABLE 2

| Switch | Switch | Switch | Switch | Switch | Switch | Detected |
|---|---|---|---|---|---|---|
| 1102 | 1104 | 1106 | 1108 | 1110 | 1112 | Motion |
| 1 | 1 | 0 | 0 | 0 | 0 | Move in |
| | | | | | | positive di- |
| | | | | | | rection along |
| | | | | | | the axis 602 |
| 0 | 0 | 0 | 1 | 1 | 0 | Move in |
| | | | | | | negative di- |
| | | | | | | rection along |
| | | | | | | the axis 602 |
| 0 | 0 | 1 | 0 | 0 | 0 | Move in |
| | | | | | | positive di- |
| | | | | | | rection along |
| | | | | | | the axis 601 |
| 0 | 0 | 0 | 0 | 0 | 1 | Move in |
| | | | | | | negative di- |
| | | | | | | rection along |
| | | | | | | the axis 601 |
| 1 | 0 | 0 | 1 | 0 | 0 | Rotate |
| | | | | | | clockwise |
| 0 | 1 | 0 | 0 | 1 | 0 | Rotate counter- |
| | | | | | | clockwise |

While the positioning sensing subsystem 1000 is shown to include eight switches and the position sensing subsystem 1100 is shown to include six switches, switch-based position sensing subsystems that use fewer switches, (e.g., four switches) or use additional sensors to detect movement in other degrees of freedom, such as along the axis 604 (see FIG. 6) may also be used.

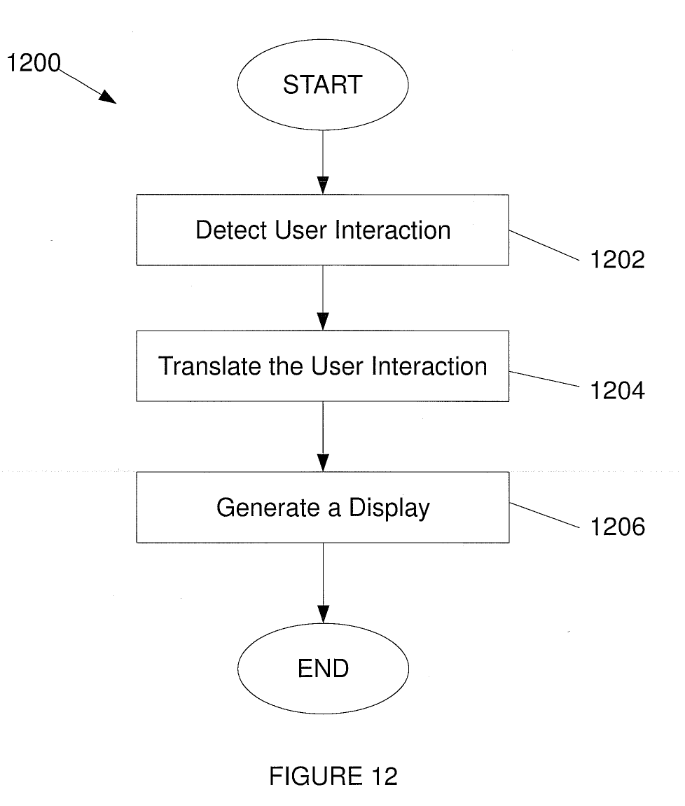

FIG. 12 illustrates a method 1200 for interfacing according to an example embodiment. The method 1200 maybe performed by the interface system 900 (see FIG. 9), or may otherwise be performed.

At block 1202, a user interaction is detected based on movement of the movable portion relative to the non-movable portion. In one embodiment, the user interaction is in the form of the manipulation of the moveable portion 102 relative to the non-moveable base unit 104 (see FIG. 1), such as sliding (orthogonal) or twisting (rotational) as described in FIGS. 6 and 7.

In some embodiments, the detection includes taking a reading of a single sensor or multiple sensors based on movement of the movable portion relative to the non-movable portion and identifying the user interaction based on the reading.

At block 1204, the user interaction is translated into a single instruction or multiple instructions to be carried out. In one embodiment, the instructions are related to updating some viewable portion of display 104 (see FIG. 1) in accordance with the user interaction.

At block 1206, a display is generated based on the instruction. The generated display may be presented on the display 506, or may otherwise be presented. In some embodiments, the generated display reflects the user interaction received at block 1202.

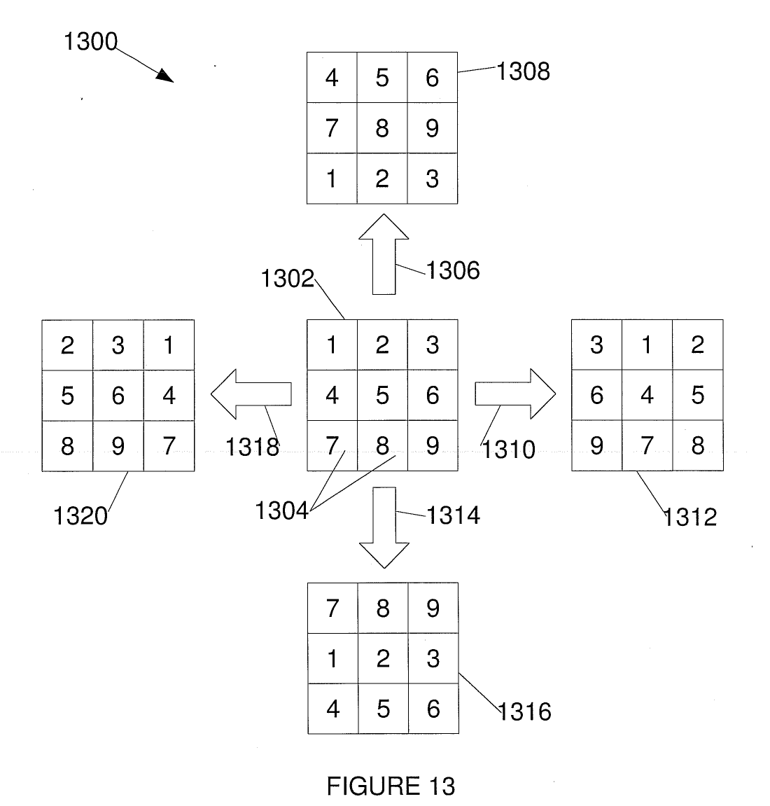

FIG. 13 illustrates example display configurations 1300, according to an example embodiment, that may be presented in combination with method 1200 (see FIG. 12) on the display 906 (see FIG. 9), other presentations may also be made on another display (e.g., on an LCD).

Display configurations 1302, 1308, 1312, 1316 and 1320 illustrate various arrangements of nine display sub-units 1304, numbered 1-9 with example data. In general, the numbers are shown for reference only. However, in one embodiment the numbers may be presented as part of the visual display. The display configuration 1302 is considered the starting configuration of the display sub-units 1304.

In one embodiment, the display configuration 1308 is the result of updating the display configuration 1302 in accordance with received user interaction indicating a shift in the direction of an arrow 1306. The display sub-units 1304 are each shifted one display sub-unit in the direction of the arrow 1306. The display sub-units 1304 that are shifted beyond the boundary of the display configuration are wrapped back to the other side.

In one embodiment, the display configuration 1312 is the result of updating the display configuration 1302 in accordance with received user interaction indicating a shift in the direction of an arrow 1310. The display sub-units 1304 are each shifted one display sub-unit in the direction of the arrow 1310. The display sub-units 1304 that are shifted beyond the boundary of the display configuration are wrapped back to the other side.

In one embodiment, the display configuration 1316 is the result of updating the display configuration 1302 in accordance with received user interaction indicating a shift in the direction of an arrow 1314. The display sub-units 1304 are each shifted one display sub-unit in the direction of the arrow 1314. The display sub-units 1304 that are shifted beyond the boundary of the display configuration are wrapped back to the other side.

In one embodiment, the display configuration 1320 is the result of updating the display configuration 1302 in accordance with received user interaction indicating a shift in the direction of an arrow 1318. The display sub-units 1304 are each shifted one display sub-unit in the direction of the arrow 1318. The display sub-units 1304 that are shifted beyond the boundary of the display configuration are wrapped back to the other side.

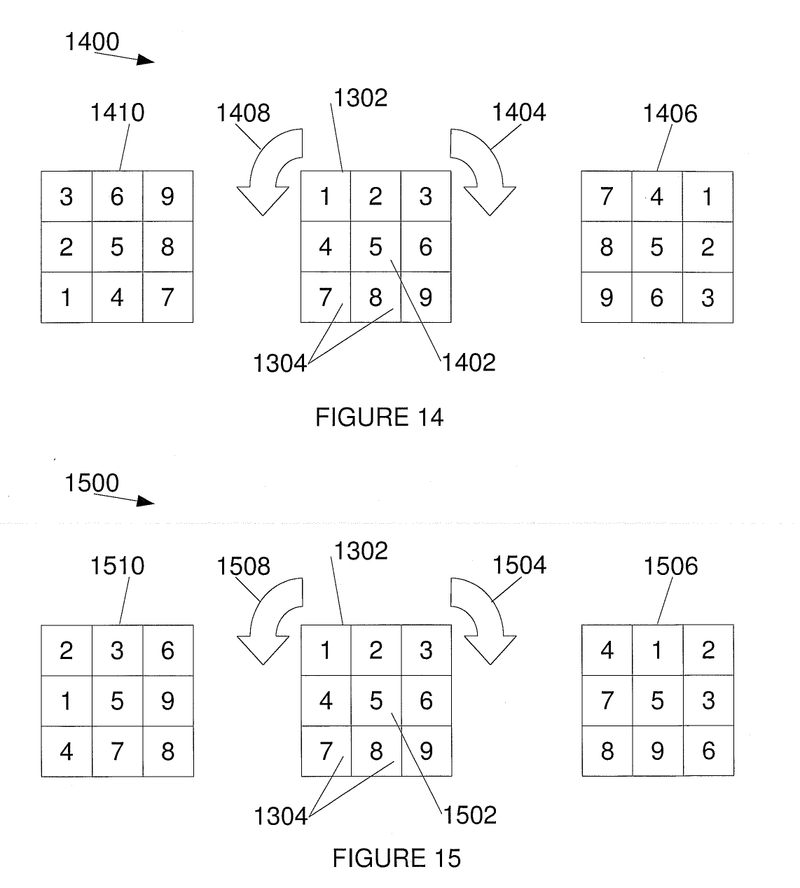

FIG. 14 illustrates example display configurations 1400, according to an example embodiment, that may be presented in combination with method 1200 (see FIG. 12) as the display 906 (see FIG. 9), other presentations may also be made on another display (e.g., on an LCD).

In one embodiment, the display configuration 1406 is the result of updating the display configuration 1302 (see FIG. 13) in accordance with received user interaction indicating a rotation about center display sub-unit 1402 in the direction of an arrow 1404. The display sub-units 1304 are each shifted two display sub-units around the perimeter of the display configuration in the direction of the arrow 1404 resulting in an apparent overall rotation of 90 degrees.

In one embodiment, the display configuration 1410 is the result of updating the display configuration 1302 in accordance with received user interaction indicating a rotation about center display sub-unit 1402 in the direction of an arrow 1408. The display sub-units 1304 are each shifted two display sub-units around the perimeter of the display configuration in the direction of the arrow 1408 resulting in an apparent overall rotation of negative 90 degrees.

FIG. 15 illustrates example display configurations 1500, according to an example embodiment, that may be presented in combination with method 1200 (see FIG. 12) as the display 906 (see FIG. 9), other presentations may also be made on another display (e.g., on an LCD).

In one embodiment, the display configuration 1506 is the result of updating the display configuration 1302 in accordance with received user interaction indicating a rotation about center display sub-unit 1502 in the direction of an arrow 1504. The display sub-units 1304 are each shifted one display sub-unit around the perimeter of the display configuration in the direction of the arrow 1504.

In one embodiment, the display configuration 1510 is the result of updating the display configuration 1302 in accordance with received user interaction indicating a rotation about center display sub-unit 1502 in the direction of an arrow 1508. The display sub-units 1304 are each shifted one display sub-unit around the perimeter of the display configuration in the direction of the arrow 1508.

Some embodiments may be used to implement an electronic handheld game. In one embodiment, the game includes the hand-manipulable interface device 100 (see FIG. 1) in combination with the position sensing subsystem 100 (see FIG. 10) or the position sensing subsystem 1100 (see FIG. 11) and the display configurations 1300, 1400 and 1500 (see FIGS. 13, 14, and 15). The display sub-units 1304 (see FIG. 13) may be areas of illumination. The illumination is provided by LEDs and may be of a single color or multiple colors. The degrees of freedom of the moveable portion 102 relative to the non-moveable base unit 104 (see FIG. 1) are described by FIGS. 13, 14 and 15. In one embodiment, there is a secondary input unit in the form of pushbuttons, and a secondary output unit in the form of a speaker that reproduces voice, sound effects, and other audio.

Several game play sequences may be implemented on a gaming interface device such as tic-tac-toe, lights out, and pattern matching, among others. One game play sequence includes the generation of a target pattern and a puzzle pattern, the goal of the player being to manipulate the displayed puzzle pattern using the hand-manipulable interface device 100 until the puzzle pattern matches the target pattern.

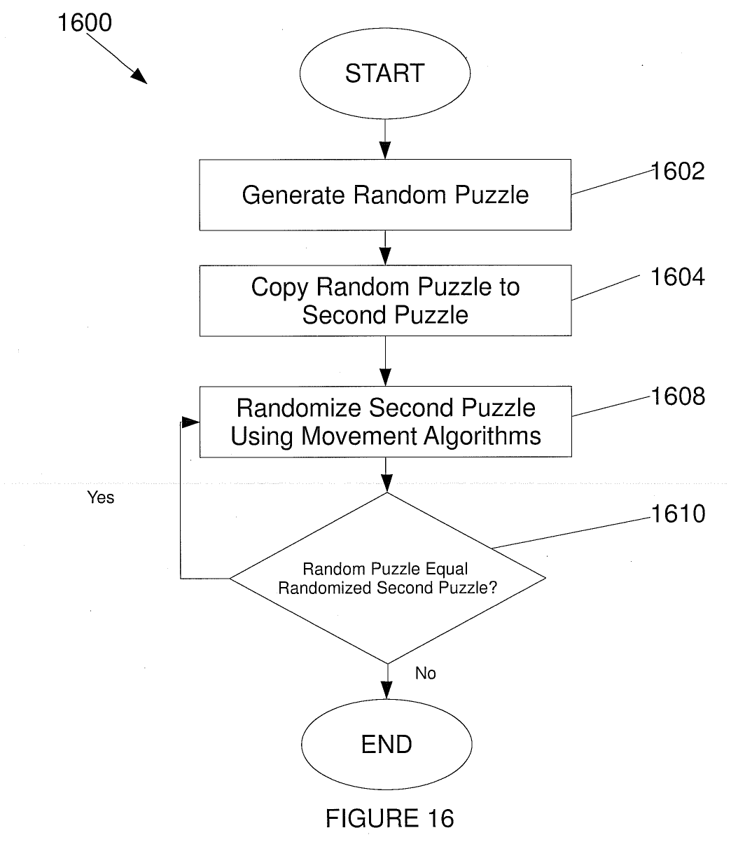

FIG. 16 illustrates the block diagram of a method for producing a random puzzle and a randomized second puzzle 1600, according to an example embodiment. The method 1600 may be performed by the controller 904 (see FIG. 9), or may otherwise be performed.

The method 1600 may be used with an electronic hand-held game. The random puzzle and randomized second puzzle may be used as the target pattern and the puzzle pattern in the game. In one embodiment, the method 1600 may enable the puzzle pattern to be modified to match the target pattern and provide a solution to the game.

In block 1602 a random puzzle pattern is generated and stored. In one embodiment, the random puzzle pattern takes the form of the display configuration 1302 (see FIG. 13) and each display sub-unit 1304 is a multi-colored, LED illuminator. For example, the pattern may include two different colors, three different colors, four different colors, five different colors, six different colors, or more than six different colors.

At block 1604, the random puzzle pattern is copied to a second puzzle. The random puzzle and the second puzzle are now equal in that they have the same pattern.

At block 1608, the second puzzle is randomized by simulating and applying various configuration modifications that, in one embodiment, are those illustrated in FIGS. 13, 14 and 15.

At description block 1610, the randomized second puzzle is compared to the random puzzle. When the puzzles are equal, the method 1600 returns to block 1608 to apply further random configuration modifications to ensure the puzzles are different.

When the puzzles are not equal, at decision block 1610, the method 1600 of producing a random puzzle and randomized second puzzle is complete. The randomized second puzzle may then be used as a target pattern for the puzzle pattern.

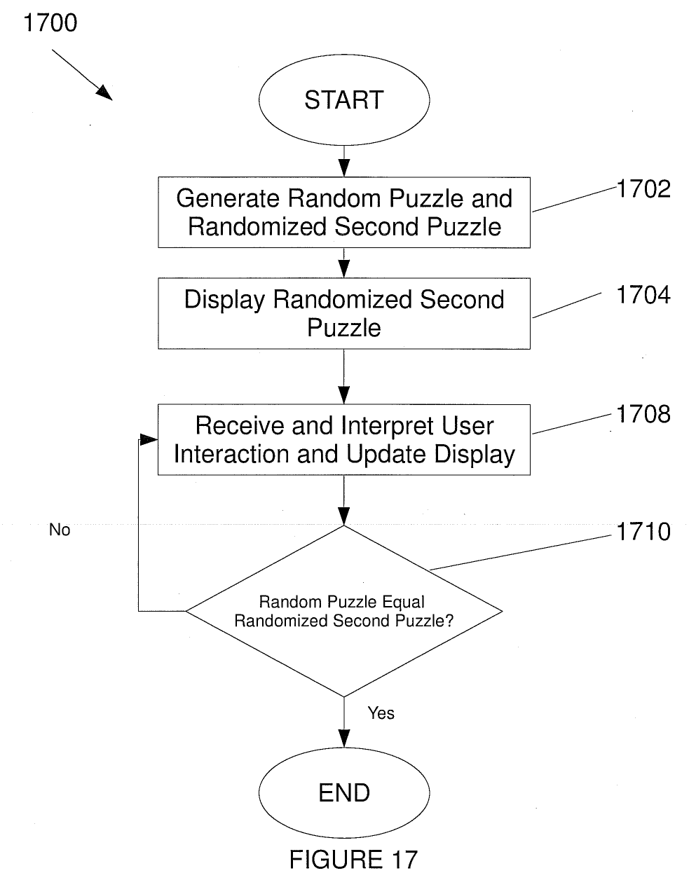

FIG. 17 illustrates the block diagram of a method 1700 of game play, according to an example embodiment. The method 1700 may be performed on the hand-manipulable interface device 100 (see FIG. 1), or may be otherwise performed.

At block 1702, puzzle data is generated. In one embodiment performed, the puzzle data is generated by the method 1600 (see FIG. 16).

At block 1704, the randomized second puzzle is presented to the user through display 104 (see FIG. 1). The operations at block 1704 may include generating a visual display of the randomized puzzle pattern in a display configuration.

At block 1708, user input is received and interpreted and, in one embodiment, the display is updated by the method 1200 (see FIG. 12). In one embodiment, a user interaction is accessed based on movement of the display configuration, the user interaction is translated into a gaming instruction, and the puzzle pattern is modified to create a modified puzzle pattern based on the gaming instruction. The user interface updates the randomized second puzzle or the puzzle pattern, while the random puzzle or target pattern remains constant.

At decision block 1710, the updated, randomized second puzzle is compared to the random puzzle. If they are not equal, the sequence returns to block 1708 to await the reception of further user interaction. If the puzzles are equal, the puzzle has been solved and the game play ends. On the end of game play, the method 1710 may generate a new puzzle, may provide a puzzle completion notification, or both.

In some embodiments, the target pattern remains constant until the puzzle has been solved. In other embodiments, the target pattern may change after a period of time without the puzzle having been solved. In still other embodiments, the target pattern may change based on a user request for a new puzzle.

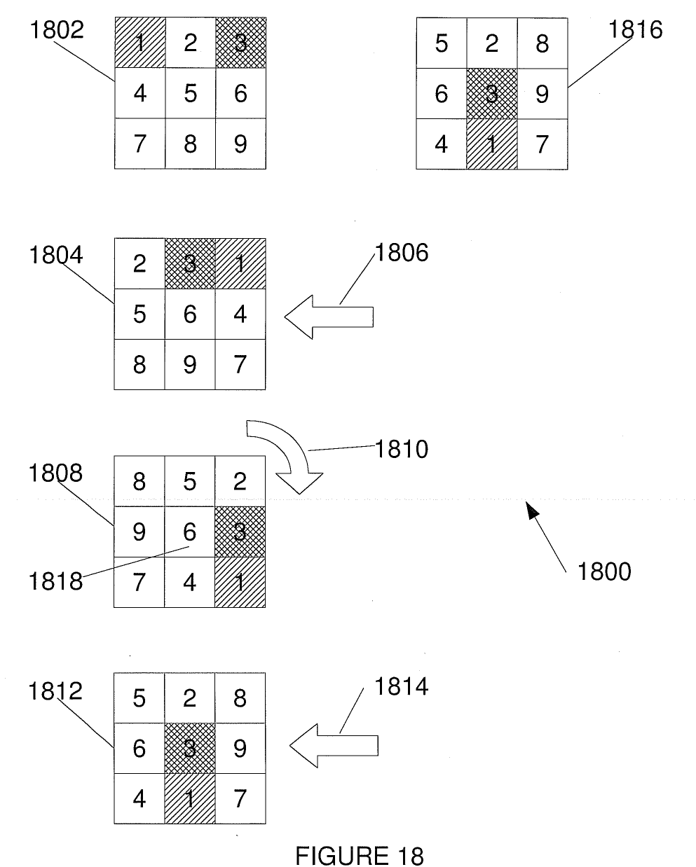

FIG. 18 is a diagram 1800 illustrating the steps of manipulating a displayed, randomized second puzzle to match a target random puzzle, according to an example embodiment. The method 1800 may be performed on the hand-manipulable interface device 100 (see FIG. 1), or may otherwise be performed.

Some display sub-units are shown in hatched or cross-hatched shading to aid in following the movement of certain display sub-unit blocks in the display configurations. In one embodiment, the hatching and cross-hatching are analogous to specific colors of illumination of those display sub-units. A display configuration 1802 indicates the displayed randomized second puzzle in its starting form. A display configuration 1816 indicates a target random puzzle. In one embodiment, the user may toggle between the randomized second puzzle and the target random puzzle through a toggle request through use of a secondary input such as pressing or holding a button. In one embodiment, shifting the display the display configuration pattern 1802 in the direction of an arrow 1806 results in display configuration 1804. Next, rotating the display configuration pattern 1804 about a display sub-unit 1818 in the direction of an arrow 1810 results in a display configuration 1808. Shifting the display configuration pattern 1808 in the direction of an arrow 1814 results in a display configuration 1812. The display configuration 1812 now matches the target random puzzle 1816.

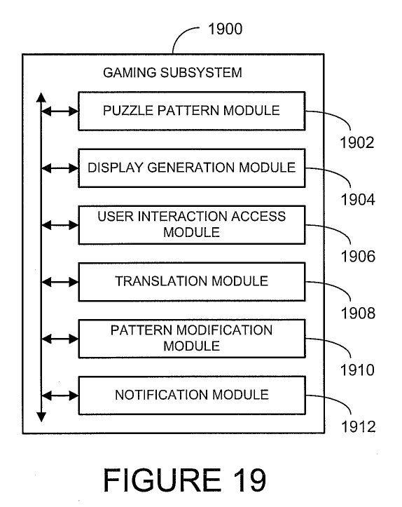

FIG. 19 illustrates an example gaming subsystem 1900 that may be deployed in the hand-manipulable interface device 100 (see FIG. 1), or otherwise deployed in another system. One or more modules are included in the gaming subsystem 1902 to enable game play. The modules of the gaming subsystem 1900 that may be included are a puzzle pattern module 1902, a display generation module 1904, a user interaction access module 1906, a translation module 1908, a pattern modification module 1910, and a notification module 1912. Other modules may also be included. In various embodiments, the modules may be distributed so that some of the modules may be deployed in the manipulable interface device 100 and some of the modules may be deployed in another device. In one particular embodiment, the gaming subsystem 1900 includes a processor, memory coupled to the processor, and a number of the aforementioned modules deployed in the memory and executed by the processor.

The puzzle pattern module 1902 generates the puzzle pattern based on the target pattern and/or accesses the puzzle pattern from storage.

The display generation module 1904 generates a visual display of a puzzle pattern in a display configuration.

The user interaction access module 1906 accesses the user interaction based on movement of the display configuration. In some embodiments, the user interaction may is accessed by receiving the user interaction through a user interface of a computing system. In other embodiments, the user interaction is accessed by detecting, on a hand-manipulable interface device 100 having a movable portion and a non-movable portion, the user interaction based on movement of the movable portion relative to the non-movable portion.

The translation module 1908 translates the user interaction into a gaming instruction. In general, the gaming instruction is an instruction for a video game.

The pattern modification module 1910 modifies the puzzle pattern to create a modified puzzle pattern based on the gaming instruction.

When the modified puzzle pattern is not the same pattern as a target pattern, display generation module 1904 generates the visual display of the modified puzzle pattern.

When the modified puzzle pattern is the same as the target pattern, the notification module 1912 providing a puzzle completion notification. The puzzle completion notification may include an audio notice, a visual notice, both an audio and a video notice, or a different type of notice.

When the modified puzzle pattern is the same as the target pattern, display generation module 1904 generates a display of an additional puzzle pattern. The additional puzzle pattern is a different pattern than the puzzle pattern.

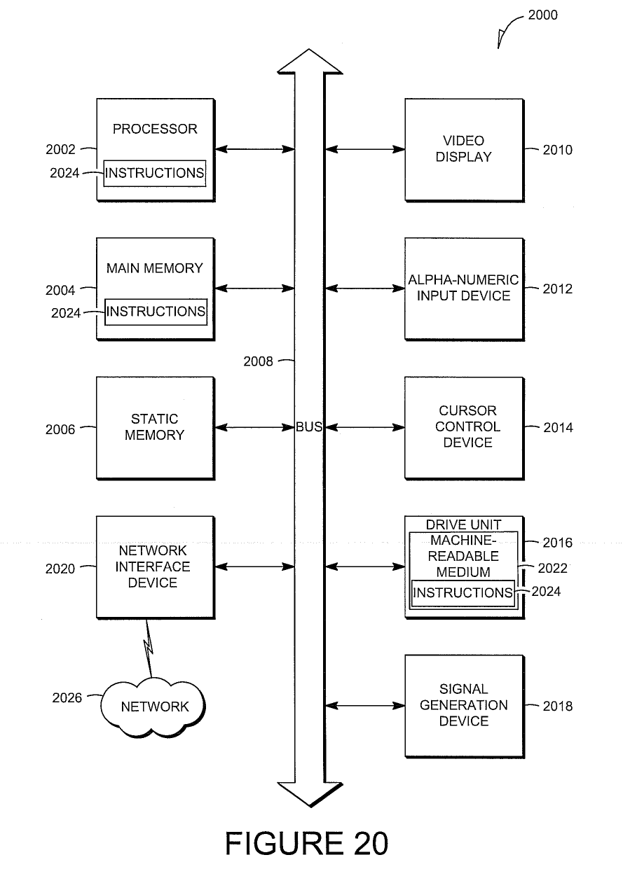

FIG. 20 shows a block diagram of a machine in the example form of a computer system 2000 within which a set of instructions may be executed causing the machine to perform any one or more of the methods, processes, operations, or methodologies discussed herein. The hand-manipulable interface device 100 (see FIG. 1) may include the functionality of the one or more computer systems 2000.

In an example embodiment, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a server computer, a client computer, a personal computer (PC), a tablet PC, a set-top box (STB), a Personal Digital Assistant (PDA), a cellular telephone, a web appliance, a network router, switch or bridge, a kiosk, a point of sale (POS) device, a cash register, an Automated Teller Machine (ATM), or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 2000 includes a processor 2012 (e.g., a central processing unit (CPU) a graphics processing unit (GPU) or both), a main memory 2004 and a static memory 2006, which communicate with each other via a bus 2008. The computer system 2000 may further include a video display unit 2010 (e.g., a liquid crystal display (LCD) or a cathode ray tube (CRT)). The computer system 2000 also includes an alphanumeric input device 2012 (e.g., a keyboard), a cursor control device 2014 (e.g., a mouse), a drive unit 2016, a signal generation device 2018 (e.g., a speaker) and a network interface device 2020.

The drive unit 2016 includes a machine-readable medium 2022 on which is stored one or more sets of instructions (e.g., software 2024) embodying any one or more of the methodologies or functions described herein. The software 2024 may also reside, completely or at least partially, within the main memory 2004 and/or within the processor 2012 during execution thereof by the computer system 2000, the main memory 2004 and the processor 2012 also constituting machine-readable media.

The software 2024 may further be transmitted or received over a network 2026 via the network interface device 2020.

While the machine-readable medium 2022 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing or encoding a set of instructions for execution by the machine and that cause the machine to perform any one or more of the methodologies of the present invention. The term “machine-readable medium” shall accordingly be taken to include, but not be limited to, solid-state memories, and optical media, and magnetic media.

The inventive subject matter may be represented in a variety of different embodiments of which there are many possible permutations.

In one embodiment, a manipulable interface device may have a movable portion and a non-moveable base portion. A position sensing subsystem may be deployed in the manipulable interface device to detect a user interaction based on movement of the movable portion relative to the non-movable portion. A control unit may be coupled to the positioning sensing subsystem to translate the user interaction into an instruction on the manipulable interface device and generate a visual display on the manipulable interface device based on the instruction.

In one embodiment, a user interaction may be detected on a manipulable interface device having a movable portion and a non-movable portion based on movement of the movable portion relative to the non-movable portion. The user interaction may be translated into an instruction on the manipulable interface device. A visual display may be generated on the manipulable interface device based on the instruction.

In one embodiment, a visual display of a puzzle pattern in a display configuration may be generated. A user interaction may be accessed based on movement of the display configuration. The user interaction may be translated into a gaming instruction. The puzzle pattern may be modified to create a modified puzzle pattern based on the gaming instruction. When the modified puzzle pattern is not the same pattern as a target pattern, the visual display of the modified puzzle pattern may be generated.

Thus, methods and systems for a hand-manipulable interface have been described. Although embodiments of the present invention have been described with reference to specific example embodiments, it will be evident that various modifications and changes may be made to these embodiments without departing from the broader spirit and scope of the embodiments of the invention. Accordingly, the specification and drawings are to be regarded in an illustrative rather than a restrictive sense.

The methods described herein do not have to be executed in the order described, or in any particular order. Moreover, various activities described with respect to the methods identified herein can be executed in serial or parallel fashion. Although “End” blocks are shown in the flowcharts, the methods may be performed continuously.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter may lie in less than all features of a single disclosed embodiment. Thus, the following claims are hereby incorporated into the Detailed Description, with each claim standing on its own as a separate embodiment.

What is claimed is:

1. A system comprising:
a manipulable interface device having a movable portion and a non-moveable base portion;
a position sensing subsystem deployed in the manipulable interface device to detect a user interaction based on movement of the movable portion relative to the non-movable base portion; and
a control unit coupled to the positioning sensing subsystem to translate the user interaction into an instruction on the manipulable interface device and generate a visual display on the manipulable interface device based on the instruction.

2. The system of claim 1, wherein the position sensing subsystem takes a reading of a sensor of the manipulable interface device, the reading based on movement of the movable portion relative to the non-movable base portion, and identifies the user interaction based on the reading.

3. The system of claim 2, wherein the sensor includes a plurality of pushbuttons deployed within the movable portion.

4. The system of claim 2, wherein the sensor includes a plurality of pushbuttons deployed within the non-movable base portion.

6. The system of claim 1, further comprising:
a display deployed in the movable portion and coupled to the control unit to display the visual display.

7. The system of claim 1, wherein the manipulable interface device has a rectangular, square, circular, spherical, or trapezoidal shape.

8. The system of claim 1, further comprising:
an input unit coupled to the control unit to receive an additional input,
wherein the control unit generates the visual display based on the instruction and the additional input.

9. The system of claim 1, further comprising:
an output unit coupled to the position sensing subsystem to generate an additional output based on the instruction.

10. A method comprising:
detecting, on a manipulable interface device having a movable portion and a non-movable base portion, a user interaction based on movement of the movable portion relative to the non-movable base portion;
translating the user interaction into an instruction on the manipulable interface device; and
generating a visual display on the manipulable interface device based on the instruction.

11. The method of claim 10, wherein detecting comprises:
taking a reading of a sensor of the manipulable interface device, the reading based on movement of the movable portion relative to the non-movable base portion; and
identifying the user interaction based on the reading.

12. The method of claim 10, wherein the movement is translation movement.

13. The method of claim 10, wherein the movement is rotational movement.

14. A method comprising:
generating a visual display of a puzzle pattern in a display configuration;
accessing a user interaction based on movement of the display configuration;
translating the user interaction into a gaming instruction;
modifying the puzzle pattern to create a modified puzzle pattern based on the gaming instruction; and
when the modified puzzle pattern is not the same pattern as a target pattern, generating the visual display of the modified puzzle pattern.

15. The method of claim 14, further comprising:
when the modified puzzle pattern is the same as the target pattern, providing a puzzle completion notification.

16. The method of claim 14, further comprising:
when the modified puzzle pattern is the same as the target pattern, generating a display of an additional puzzle pattern, the additional puzzle pattern being a different pattern than the puzzle pattern.

17. The method of claim 14, further comprising:
generating the puzzle pattern based on the target pattern, wherein generating the visual display is based on generating the puzzle pattern.

18. The method of claim 14, further comprising:
accessing the puzzle pattern from storage, the puzzle pattern being associated with the target pattern.

19. The method of claim 14, wherein accessing the user interaction comprises:
receiving the user interaction through a user interface of a computing system.

20. The method of claim 14, wherein accessing the user interaction comprises:
detecting, on a manipulable interface device having a movable portion and a non-movable based portion, the user interaction based on movement of the movable portion relative to the non-movable base portion.

21. The method of claim 14, further comprising:
receiving a toggle request; and
generating a visual display of the target pattern in the display configuration in response to receiving the toggle request.

22. The method of claim 14, wherein the display configuration is associated with the movable portion.

23. The method of claim 14, wherein the puzzle pattern includes a plurality of illuminated LEDS, a first portion of the plurality of illuminated LEDS being a first color, a second portion of the plurality of illuminated LEDS being a second color, the second color being different than the first color, and a third portion of the plurality of illuminated LEDS being a third color, the third color being different than the first color and the second color.

24. A machine-readable non-transitory medium comprising instructions, which when executed by one or more processors, cause the one or more processors to perform the following operations:
generate a visual display of a puzzle pattern in a display configuration;
access a user interaction based on movement of the display configuration;
translate the user interaction into a gaming instruction;
modify the puzzle pattern to create a modified puzzle pattern based on the user interaction; and
when the modified puzzle pattern is not the same pattern as a target pattern, generate the visual display of the modified puzzle pattern.
